(19) United States
(12) Patent Application Publication
(10) Pub. No.: US 2014/0308627 A1
(43) Pub. Date: Oct. 16, 2014

(54) PROXIMAL TOOTH SEPARATOR

(71) Applicant: Hugh James Howard, La Verkin, UT (US)

(72) Inventor: Hugh James Howard, La Verkin, UT (US)

(21) Appl. No.: 14/254,650

(22) Filed: Apr. 16, 2014

Related U.S. Application Data
(60) Provisional application No. 61/812,429, filed on Apr. 16, 2013.

(51) Int. Cl. A61C 5/12; A61C 3/06

(52) U.S. Cl. CPC A61C 5/12; A61C 3/06
USPC 433/142; 433/148; 433/147; 433/215

(57) ABSTRACT

The present disclosure is directed to a proximal tooth separator. One embodiment comprises a handle and at least one separator connected to an end. The at least one separator comprising rigid metals, steel, titanium, or other materials suitable for separating teeth, and being sized so as to appropriately separate the teeth as known to those of skill in the art.

### CROSS-REFERENCE TO RELATED APPLICATIONS

This application claims the benefit of U.S. Provisional Application Ser. No. 61/812,429, filed on Apr. 16, 2013, which is incorporated herein by reference.

### TECHNICAL FIELD

The present disclosure relates to dental tools. More specifically, the current disclosure relates to a device that separates, sands, and smoothes proximal contacts between teeth.

### BACKGROUND

A common problem for dentists and/or orthodontists is the ability to ensure that optimal proximal contacts exist (i.e., that there is the correct amount of interproximal space between adjacent teeth). Often times, a patient may have difficulty flossing if hardened cement or fillings obstruct the gap between the teeth. Conventional proximal separators can be difficult to use, especially when attempting to work with the molars. Current separators are also not well-suited for smoothing or eliminating any extrusions or obstructions, particularly in the posterior region of the mouth.

Further, it may be desired to create a larger proximal gap to facilitate the realignment of teeth using methods such as Invisalign®. The present invention seeks to solve these and other problems.

### SUMMARY OF EXAMPLE EMBODIMENTS

In one embodiment, a proximal tooth separator comprises a handle and at least one separator affixed to an end. The at least one separator comprising rigid metals, steel, titanium, or other materials suitable for separating teeth, and being sized so as to appropriately separate the teeth as known to those of skill in the art.

In another embodiment, a proximal tooth separator comprises a handle, a first separator, and a second separator. At least one separator comprising an abrasive surface for sanding and smoothing the proximal contacts of teeth. The abrasive surface may comprise a diamond coating or any other suitable material known to those in the art.

In another embodiment, a proximal separator tool comprises a handle, a coupling means, and at least one removable end. The coupling means may comprise a threaded end portion, a snap-on end, a twist-and-lock end, or any other means known to those of skill in the art.

In yet another embodiment, a proximal tooth separator comprises a separator at one end and a multi-purpose set of grooves, notches, and/or apertures that permit several additional uses, such as seating a veneer or crown, or checking for a cracked tooth, at a second end.

### BRIEF DESCRIPTION OF THE DRAWINGS

FIG. 1 is a side elevation view of a proximal tooth separator with two separators

FIG. 2 is a top view of a proximal tooth separator with two separators

FIG. 3 is a side elevation view of a proximal tooth separator with interchangeable ends

FIG. 4 illustrates a proximal tooth separator being used in a patient's mouth

FIG. 5A is a perspective view of a multi-purpose proximal tooth separator

FIG. 5B is a side elevation view of a multi-purpose proximal tooth separator

FIG. 5C is a top view of a multi-purpose proximal tooth separator

### DETAILED DESCRIPTION OF EXAMPLE EMBODIMENTS

The following descriptions depict only example embodiments and are not to be considered limiting of its scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

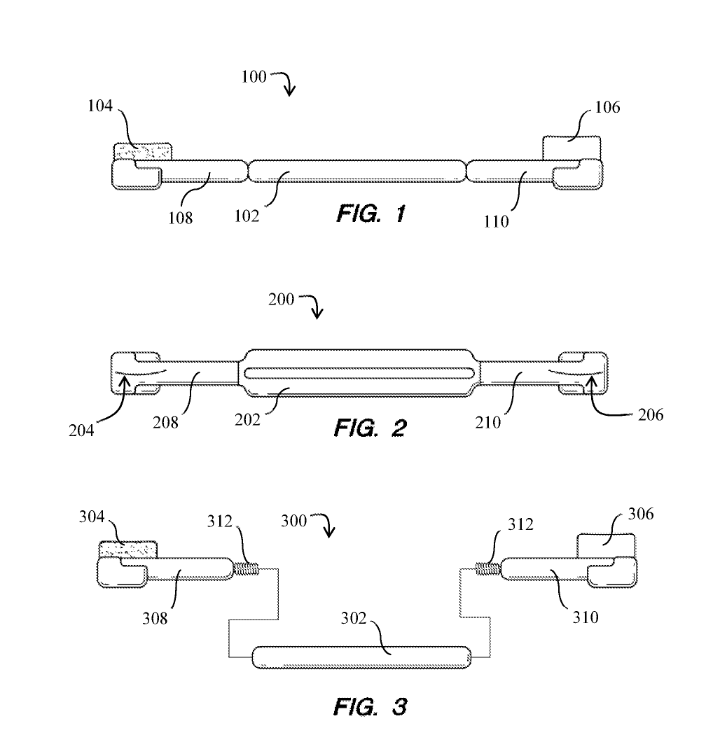

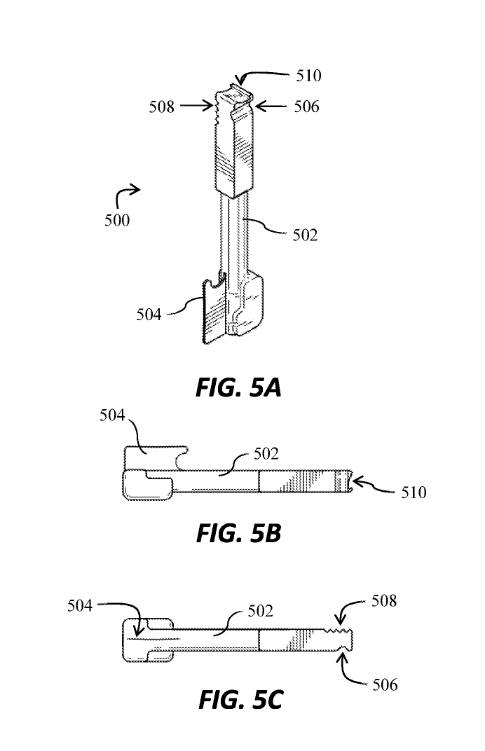

The present disclosure is directed to proximal separators in the dental industry. In general, as illustrated in FIG. 1, a proximal tooth separator 100 comprises a handle 102 and two separators 104, 106. Although FIG. 1 shows two separators, 104 and 106, only one is required. The separators 106, 106 are attached to end portions 108, 110 and are made from rigid metals, steel, titanium, or other materials suitable for separating teeth. Further, separators 104, 106 are sized so as to appropriately separate the teeth (as seen in FIG. 5) as known to those of skill in the art. It is noted that the sizing of each separator 104, 106 may vary, depending upon the particular use. For example, a first separator 104 may be shorter than a second separator 106 to increase stability of the separator when a large amount of force is needed to insert the separator 104 between teeth. Once first separator 104 has sanded and created sufficient space, a user may then desire to use the longer, second separator 106. Further, end portions 108, 110 may be removably attachable (e.g., threaded), permanently affixed (e.g., adhesives), or of single manufacture with the handle. As shown, end portions 108, 110 may be in the same plane as handle 102, but may also be perpendicular to handle 102. Handle 102 is comprised of plastics, metals, carbon fibers, or other materials that can withstand the pressure of a user biting down on the surface to separate and smooth teeth and the force that a dentist will exert when forcing it between tooth contacts.

Separators 104, 106 may be flat or slightly curved (as shown in FIG. 2) so as to advantageously fit between teeth. As illustrated, one or more of the separators 104, 106 may have an abrasive texture, as shown on separator 104, or may be smooth as shown on separator 106 to simply facilitate the separating of proximal contacts during dental procedures. The abrasive texture may be made from diamonds or other materials common in the art of abrasion and sanding.

FIG. 2 illustrates a top view of a proximal tooth separator 200. Handle 202 is connected to end portions 208, 210, which have separators 204, 206. As shown, the separators 204, 206 are slightly curved, which adds not only strength to the separator, but also allows easier insertion between the proximal contacts of the molar teeth.

In another embodiment of the present invention, as seen in FIG. 3, a proximal tooth separator 300 comprises a handle 302, coupled to at least one removable end 308, 310 for exchanging separators 304, 306. The coupling means may be threaded ends 312 as shown, or may be snap-on ends, twist-and-lock ends, or any other means known to those of skill in the art. When a user, such as a dentist, desires to use a different separator 304, 406, he or she simply disconnects an end portion 308, 310 from handle 302 and changes it for another. This allows the user to use multiple separators with one handle, thereby saving on cost as well as space, while allowing for a variety of separators to be used to match the need of the patient.

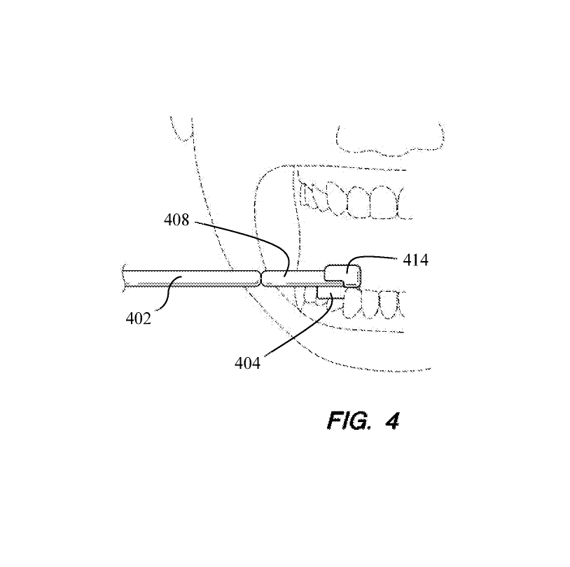

As can be more fully seen in FIG. 4, a user, such as a dentist, would hold handle 402 of proximal separator 400, place the separator 404 between the teeth in need of separating, and instruct the patient to bite down on end portion 408 or otherwise apply pressure, forcing the separator 404 between the teeth. As shown in the figures, the opposite side 414 of the separator 404 may be enlarged, allowing for a greater bite surface area. The user may then maneuver handle 402 such that the abrasive qualities will then sand and smooth the target area, allowing the user to create an optimal proximal contact as known to those of skill in the art.

FIGS. 5A-5C illustrate a multi-purpose proximal separator 500. A handle 502 has a separator 504 at one end and a set of grooves 506, notches 508, and/or apertures 510 at the opposite end. For example, the grooves 506 and notches 508 may be used to diagnose cracked-tooth syndrome, and apertures 510 may be used to seat a veneer or crown.

What is claimed is:

1. A proximal tooth separator, comprising:
a handle; and
at least one separator connected to an end portion.

2. The proximal tooth separator of claim 1, wherein the handle and end portion is of one continuous manufacture comprising plastics, metals, or carbon fibers.

3. The proximal tooth separator of claim 1, wherein the handle and end portion are coupled to one another using a coupling means.

4. The proximal tooth separator of claim 3, wherein the coupling means is a threaded end portion, a snap-on end portion, or a twist-and-lock end portion.

5. The proximal tooth separator of claim 1, wherein the at least one separator is made from metal and is straight.

6. The proximal tooth separator of claim 1, wherein the at least one separator is made from metal and is curved.

7. The proximal tooth separator of claim 1, wherein the at least one separator has an abrasive texture.

8. The proximal tooth separator of claim 7, wherein the abrasive texture is made using diamonds.

9. A multi-purpose proximal tooth separator, comprising:
a handle;
a tooth separator at one end; and
a series of grooves, notches, and/or apertures at a second end.

10. The proximal tooth separator of claim 9, wherein the handle and end portion is of one continuous manufacture comprising plastics, metals, or carbon fibers.

11. The proximal tooth separator of claim 9, wherein the at least one separator is made from metal and is straight.

12. The proximal tooth separator of claim 9, wherein the at least one separator is made from metal and is curved.

13. The proximal tooth separator of claim 9, wherein the at least one separator has an abrasive texture.

14. The proximal tooth separator of claim 13, wherein the abrasive texture is made using diamonds.

15. A method of separating and smoothing adjacent teeth, the method comprising:
holding a proximal tooth separator by the handle that has a least one tooth separator on an end portion;
placing the tooth separator between the patient's teeth;
instructing the patient to bite down on the end portion, forcing the tooth separator between the desired teeth; and
working the tooth separator and smoother by rocking the handle and also by using forward and backward motions.

16. The proximal tooth separator of claim 15, wherein the handle and end portion is of one continuous manufacture comprising plastics, metals, or carbon fibers.

17. The proximal tooth separator of claim 15, wherein the at least one separator is made from metal and is straight.

18. The proximal tooth separator of claim 15, wherein the at least one separator is made from metal and is curved.

19. The proximal tooth separator of claim 15, wherein the at least one separator has an abrasive texture.

20. The proximal tooth separator of claim 19, wherein the abrasive texture is made using diamonds.

21. The proximal tooth separator of claim 15, wherein a second end portion is a multi-purpose set of grooves, notches, and/or apertures.
